(19) United States
(12) Patent Application Publication
(10) Pub. No.: US 2021/0180511 A1
(43) Pub. Date: Jun. 17, 2021

(54) TURBOCHARGER

(71) Applicant: MITSUBISHI HEAVY INDUSTRIES MARINE MACHINERY & EQUIPMENT CO., LTD., Nagasaki-shi, Nagasaki (JP)

(72) Inventors: Takeshi Tsuji, Nagasaki (JP); Yoshihisa Ono, Nagasaki (JP); Hidetaka Nishimura, Nagasaki (JP); Ichiro Hirakawa, Nagasaki (JP)

(73) Assignee: MITSUBISHI HEAVY INDUSTRIES MARINE MACHINERY & EQUIPMENT CO., LTD., Nagasaki-shi, Nagasaki (JP)

(21) Appl. No.: 16/771,426

(22) PCT Filed: Dec. 7, 2018
(86) PCT No.: PCT/JP2018/045155

§ 371 Date: Jun. 10, 2020

(30) Foreign Application Priority Data
Dec. 13, 2017 (JP) 2017-238693

(51) Int. Cl. F02B 39/10; F02B 37/10

(52) U.S. Cl. CPC F02B 39/10; F02C 6/12; F02B 37/10

(57) ABSTRACT

A turbocharger includes: a suction part (10b) configured to suction a fluid; an impeller (12) configured to compress the fluid supplied from the suction part (10b); a drive shaft (18) having one end to which the impeller (12) is attached; an intermediate shaft (16) provided at the one end of the drive shaft (18) such that the drive shaft (18) extends in an axial direction from a downstream side to an upstream side of the impeller (12); a motor (14) or a generator having a rotor (14a) attached to a distal end of the intermediate shaft (16) via a coupling (20a), a stator (14c) provided so as to correspond to the rotor (14a), and a body portion (14b) configured to hold the stator (14c); and a cover (30) formed into a tubular shape to surround the intermediate shaft (16) and the coupling (20a).

### TECHNICAL FIELD

The present disclosure relates to a turbocharger that is suitably employed in a diesel engine or the like provided in a ship, for example.

### BACKGROUND ART

In the related art, turbochargers configured to compress air and supply the air as combustion air for internal combustion engines into combustion chambers are known. The turbochargers have widely been used in two-stroke low-speed engines such as diesel engines for ships and diesel engines for power generation, for example. Such a turbocharger is adapted such that a compressor configured to compress the combustion air and a turbine that serves as a drive source for the compressor are coupled to each other via a rotor shaft, are accommodated in a casing, and integrally rotate. The turbine is driven using exhaust gas discharged from an internal combustion engine as a drive source, for example.

As a type of turbocharger, a hybrid turbocharger in which an electric-powered generator is connected to a rotor shaft via a coupling is known (see Patent Literature 1, for example). The hybrid turbocharger can compress air and supply the air as combustion air into a combustion chamber of an internal combustion engine similarly to an ordinary turbocharger and can also generate power using excessive exhaust gas discharged from the internal combustion engine.

In addition, as a type of turbocharger, a power-assisted turbocharger in which an electric motor is connected to a rotor shaft is known (see Patent Literature 2, for example). The power-assisted turbocharger has a motor downsized by omitting a power generating function of an electric-powered generator used in a hybrid turbocharger and narrowing its function to an electric motor function (assisting function).

### CITATION LIST

### Patent Literature

### [PTL 1]

### the Publication of Japanese Patent No. 4648347

### [PTL 2]

### Japanese Unexamined Patent Application, Publication No. 2015-158161

### SUMMARY OF INVENTION

### Technical Problem

In a case of a turbocharger with an overhang structure in which no bearing is provided at a motor rotor itself, the motor rotor is connected to an extended portion of a rotor shaft of the turbocharger, and the motor rotor is supported by the rotor shaft of the turbocharger as in Patent Literature 2, a motor and an impeller inlet are inevitably located close to each other, and it is thus possible to use air flowing into the impeller for cooling the motor. However, in a case of a turbocharger with a coupling structure in which a motor is connected to a drive shaft, which is connected to a turbine, via an intermediate shaft and a coupling, the motor and an impeller inlet are separated from each other, it is thus difficult to use air flowing into the impeller for cooling the motor, and it is necessary to additionally provide a cooling mechanism such as a cooling water circulation mechanism as in Patent Literature 1 in order to sufficiently cool the motor.

The present disclosure has been made in view of such circumstances, and an object of the present disclosure is to provide a turbocharger capable of efficiently guiding a fluid to an impeller and improving cooling performance of the motor or the generator even in a turbocharger with a coupling structure.

### Solution to Problem

In order to solve the aforementioned problems, the turbocharger employs the following means.

In other words, a turbocharger according to an aspect of the present disclosure includes: a suction part configured to suction a fluid; an impeller configured to compress the fluid supplied from the suction part; a drive shaft having one end to which the impeller is attached; an intermediate shaft provided at the one end of the drive shaft such that the drive shaft extends in an axial direction from a downstream side to an upstream side of the impeller; a motor or a generator having a rotor attached to a distal end of the intermediate shaft via a coupling, a stator provided so as to correspond to the rotor, and a body portion configured to hold the stator; and a cover formed into a tubular shape to surround the intermediate shaft and the coupling.

The turbocharger according to the aspect has a coupling structure in which the rotor is attached to the distal end of the intermediate shaft via the coupling. Also, the cover with a tubular shape to surround the intermediate shaft and the coupling is provided. With this configuration, the cover can separate a flow flowing into the impeller to the outside and the inside of the cover and can curb interference between the mutual flows. Also, it is possible to uniformly reduce the flow passage area around the cover along a flowing direction of the fluid. In this manner, it is possible to reduce a pressure loss of the fluid flowing into the impeller, to rectify the fluid, and thereby to prevent a decrease in speed of the fluid. Also, it is possible to sufficiently secure the flow amount of the fluid flowing into the impeller. In other words, it is possible to efficiently guide the fluid to the impeller. At the same time, it is possible to reliably guide the fluid into the motor or into the generator (between the rotor and the stator), and cooling performance of the motor or the generator using the fluid is thus improved.

Note that it is not necessary for the cover with the tubular shape to surround the entire intermediate shaft in the longitudinal direction, and it is only necessary for the cover to surround a part of the intermediate shaft in the longitudinal direction.

Also, in the turbocharger according to an aspect of the present disclosure, the suction part is provided on an upstream side of the motor or the generator, and an inner diameter of the cover is greater than an outer diameter of the rotor.

In the turbocharger according to the aspect, the suction part is located downstream relative to the motor or the generator, and the inner diameter of the cover is greater than the outer diameter of the rotor. In this manner, it is possible to reliably guide the fluid into the motor or into the generator as well, and cooling performance of the motor or the generator using the fluid is thus improved. Therefore, it is possible to raise output power without changing a physical size of the motor or the generator. Also, it is not necessary to additionally provide a cooling mechanism for cooling the motor or the generator, which can lead to cost reduction.

Also, in the turbocharger according to an aspect of the present disclosure, an outer diameter of the cover is equivalent to an outer diameter of an end of a hub of the impeller on a side of the cover.

In the turbocharger according to the aspect, the outer diameter of the cover is equivalent to the outer diameter of the end of the hub on the side of the cover. In this manner, it is possible to secure a flow passage area of the fluid flowing into the impeller and to smooth the flow of the fluid.

Also, in the turbocharger according to an aspect of the present disclosure, the cover is splittable along a longitudinal direction.

In the turbocharger according to the aspect, the cover is splittable along the longitudinal direction. Since the motor (or the generator), the intermediate shaft, the coupling, and the like are concentrated in a location to which the cover is attached, a working space is limited. The splittable cover improves assembling properties.

Also, in the turbocharger according to an aspect of the present disclosure, the cover is provided with a rib along a longitudinal direction.

In the turbocharger according to the aspect, the cover is provided with the rib along the longitudinal direction. In this manner, it is possible to secure strength even in a case in which the cover is formed into a thin structure. In other words, it is possible to achieve weight reduction and to secure the strength of the cover.

Also, in the turbocharger according to an aspect of the present disclosure, the cover is attached on a side of the motor or on a side of the generator.

In the turbocharger according to the aspect, the cover is attached on the side of the motor or on the side of the generator. In this manner, it is not necessary to additionally provide a support structure for placing the cover, and it is possible to achieve cost reduction.

### Advantageous Effects of Invention

According to the turbocharger of the present disclosure, it is possible to efficiently guide the fluid to the impeller and to improve cooling performance of the motor or the generator even in a turbocharger with a coupling structure.

### BRIEF DESCRIPTION OF DRAWINGS

FIG. 1 is a vertical sectional view illustrating a turbocharger according to an embodiment of the present disclosure.

FIG. 2 is a sectional view of a motor illustrated in FIG. 1 taken along the cut line A-A.

FIG. 3 is a right side view of an upper cover illustrated in FIG. 1.

FIG. 4 is a bottom view of the upper cover illustrated in FIG. 3.

FIG. 5 is a right side view of a lower cover illustrated in FIG. 1.

FIG. 6 is a plan view of the lower cover illustrated in FIG. 5.

### DESCRIPTION OF EMBODIMENTS

Hereinafter, a turbocharger according to an embodiment of the present disclosure will be described with reference to drawings.

First, a configuration of a turbocharger 10 according to the embodiment will be described.

The turbocharger 10 is a turbocharger such as a hybrid turbocharger or a power-assisted turbocharger used for enhancing combustion efficiency of a diesel engine (internal combustion engine) used for a ship, for example, by raising a pressure of air (gas) to be supplied to the diesel engine to be equal to or greater than a specific pressure (atmospheric pressure, for example).

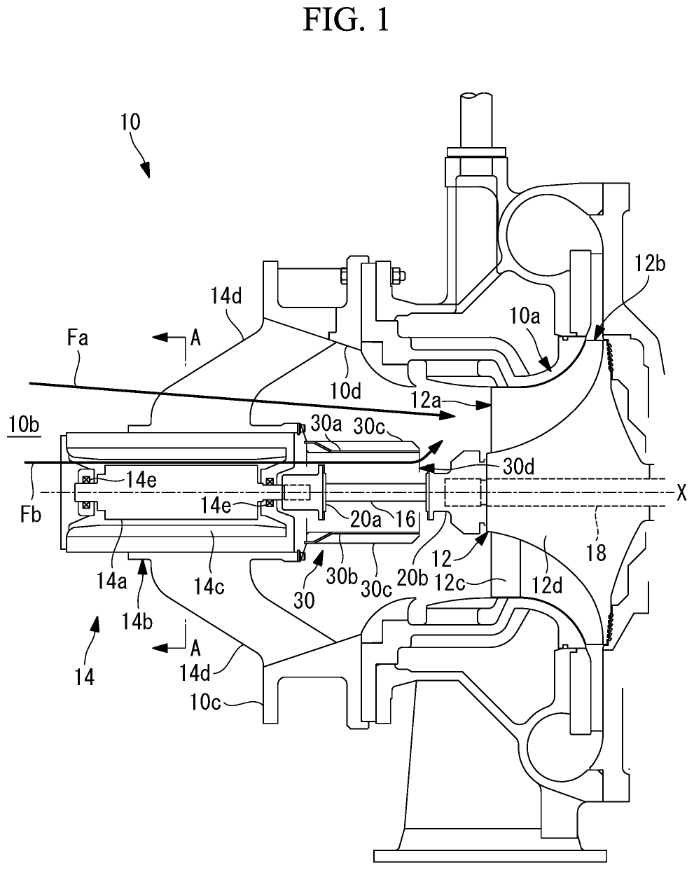

As illustrated in FIG. 1, the turbocharger 10 includes a drive shaft 18, a compression unit 10a, an intermediate shaft 16, a motor 14, a suction part 10b, and a cover 30.

The compression unit 10a is provided with an impeller 12. The impeller 12 includes a hub 12d and a plurality of blades 12c provided at the hub 12d. The impeller 12 is attached to the drive shaft 18, which is supported by a bearing (not illustrated) so as to be able to rotate about an axial line X, on a side of one end. Also, a turbine (not illustrated) that is driven and rotated by exhaust gas discharged from the diesel engine is provided at the drive shaft 18 on a side of the other end. In other words, the impeller 12 provided at the compression unit 10a is coupled to the turbine (not illustrated) via the drive shaft 18.

On the side of the one end of the drive shaft 18 to which the impeller 12 is attached, the intermediate shaft 16 that is on a coaxial line of the drive shaft 18 is provided in a direction in which the drive shaft 18 extends along the axial line X from the impeller 12 toward the upstream side of an air flow (from the right side toward the left side in FIG. 1). The drive shaft 18 and the intermediate shaft 16 are coupled to each other via a second coupling 20b. Note that the drive shaft 18 may extend in the axial direction and the extended portion of the drive shaft 18 may be caused to serve as a shaft corresponding to the intermediate shaft 16 without providing the second coupling 20b.

On the other hand, the motor 14 is mounted on the intermediate shaft 16 on a side of an end (the left side in FIG. 1) to which the drive shaft 18 is not coupled. The motor 14 includes a rotor 14a, a stator 14c provided with a clearance in a radial direction of the rotor 14a, and a body portion 14b configured to hold the stator 14c. The body portion 14b includes a plurality of supports 14d extending in the radial direction. The stator 14c is supported relative to a casing 10c of the turbocharger 10 by the body portion 14b provided with these supports 14d.

Both ends of the rotor 14a are supported by a bearing 14e provided at the body portion 14b so as to be able to rotate about the axial line X. Also, an end of the rotor 14a on the side of the intermediate shaft 16 (the right side in FIG. 1) and the intermediate shaft 16 are coupled to each other via a first coupling 20a.

The turbocharger 10 according to the embodiment employs a so-called coupling structure in which the rotor 14a is attached to the end of the intermediate shaft 16 via the first coupling 20a as described above.

The suction part 10b of the turbocharger 10 is provided at the motor 14 on the side to which the intermediate shaft 16 is not coupled, and an external fluid is suctioned from the suction part 10b. A silencer, for example, is provided on the upstream side of the suction part 10b.

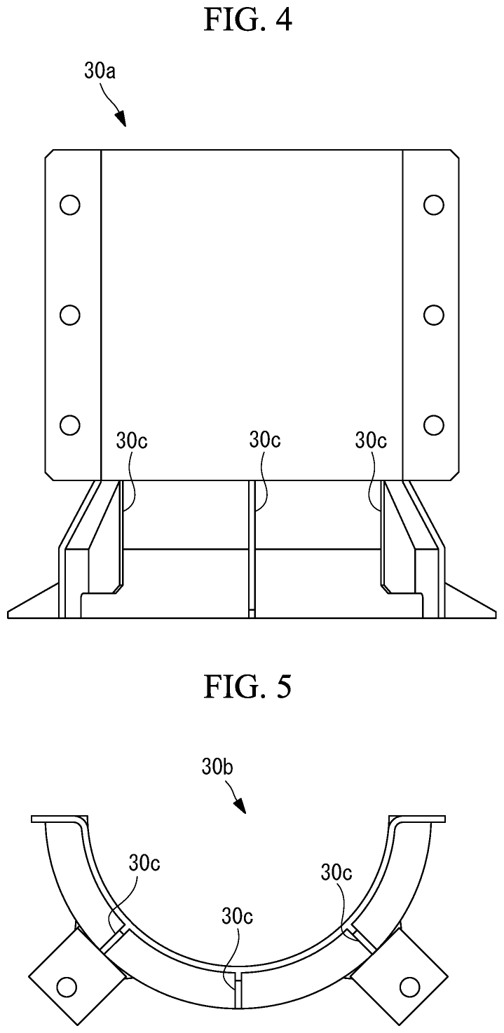

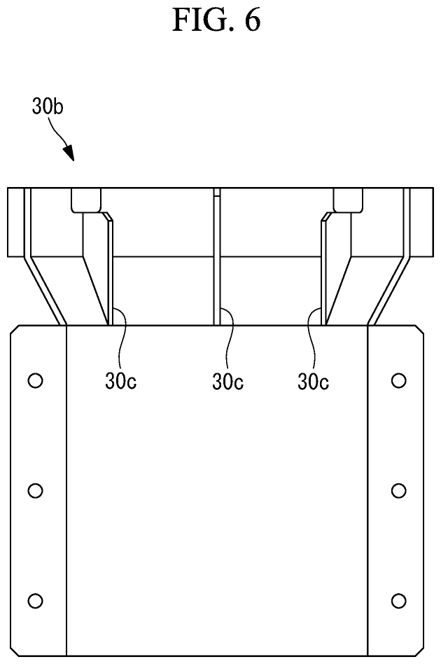

Also, the turbocharger 10 according to the embodiment includes a cover 30 formed into a tubular shape to surround the intermediate shaft 16 and the first coupling 20a. The cover 30 has a substantially cylindrical shape and has a structure in which the cover 30 can be split into halves along a longitudinal direction. In other words, the cover 30 is configured of an upper cover 30a as illustrated in FIGS. 3 and 4 and a lower cover 30b as illustrated in FIGS. 5 and 6. Also, a plurality of ribs 30c standing along the longitudinal direction are provided at each of the upper cover 30a and the lower cover 30b on a side of an outer periphery of a cylindrical surface formed of a thin plate. At this time, the inner diameter of the cover 30 is greater than the outer diameter of the rotor 14a and is set to be similar to or greater than the inner diameter of the stator 14c as illustrated in FIG. 1. Also, the outer diameter of the cover 30 is set to be equivalent to the hub diameter of the impeller 12. The hub diameter is an outer diameter of the end of the hub 12d on the side of the cover 30. One end of the cover 30 is secured to the supports 14d disposed at the intermediate shaft 16 on the side of the motor 14. Note that the support may be provided from an air inlet guide 10d to secure the cover 30. Also, the cover 30 with a tubular shape does not necessarily surround the entire intermediate shaft 16 in the longitudinal direction, and it is only necessary for the cover 30 to surround a part of the intermediate shaft 16 in the longitudinal direction. In addition, the shape of the cover 30 with a tubular shape is not limited to a cylindrical shape and may be a polygonal tubular shape.

Next, the turbocharger 10 according to the embodiment will be described in further detail.

As illustrated in FIG. 1, the impeller 12 included in the compression unit 10a is attached to the drive shaft 18, which extends along the axial line X, on the side of one end and rotates about the axial line X with rotation of the drive shaft 18 about the axial line X. The turbine (not illustrated) is attached to the drive shaft 18 on the side of the other end to which the impeller 12 is not attached. The drive shaft 18 rotates about the axial line X with rotation of the turbine about the axial line X. In other words, the impeller 12, the drive shaft 18, and the turbine integrally rotate about the axial line X.

In the turbocharger 10, exhaust gas discharged from the diesel engine causes the turbine to rotate about the axial line X. With the rotation of the turbine, the impeller 12 rotates about the axial line X via the drive shaft 18. By the impeller 12 rotating about the axial line X, the fluid flowing from a suction port 12a is compressed and is then discharged from a discharge port 12b. Once the impeller 12 starts to rotate about the axial line X (once the compression starts), a negative pressure is generated in the vicinity of the suction port 12a. External fluid is suctioned from the suction part 10b using the negative pressure. In other words, a flow of the fluid from the suction part 10b toward the compression unit 10a is formed.

The flow of the fluid from the suction part 10b to the compression unit 10a is roughly classified into a cooling air flow Fb that is distributed to the inside of a clearance between the rotor 14a and the stator 14c and a suctioned air flow Fa other than the cooling air flow Fb. Note that these names of the flows of the fluid are names for distinguishing the flows and do not mean that only the cooling air flow Fb acts for cooling the motor 14, for example.

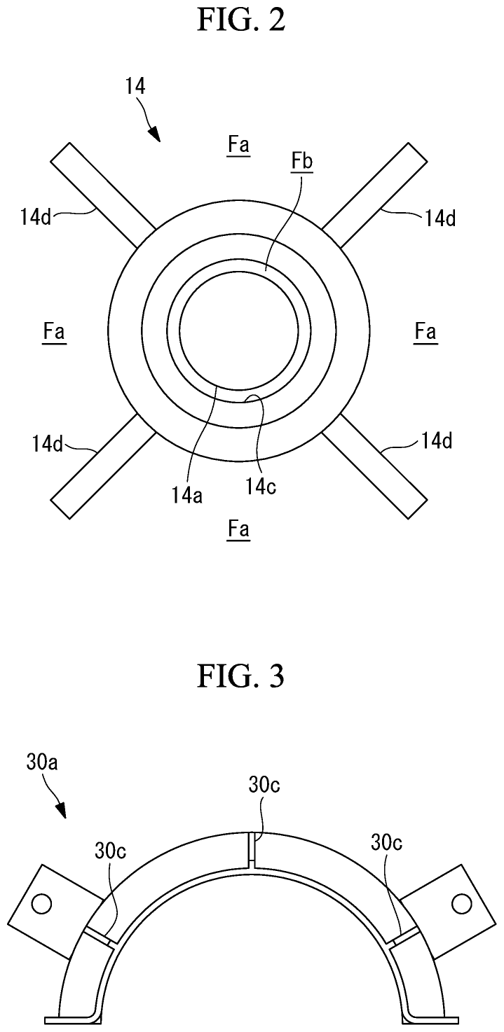

The suctioned air flow Fa passes through portions between the supports 14d (see FIG. 2) from the suction part 10b and is guided to the suction port 12a of the impeller 12.

On the other hand, the cooling air flow Fb passes through the inside of the clearance between the rotor 14a and the stator 14c. The cooling air flow Fb passing through the inside of the clearance takes away a heat of the motor 14, which has generated a heat, and as a result, the cooling air flow Fb acts for cooling the motor 14. Note that the suctioned air flow Fa acts for cooling the motor 14 from the outside of the body portion 14b.

The cooling air flow Fb that has flowed out from the clearance between the rotor 14a and the stator 14c is guided into the cover 30 that surrounds the first coupling 20a and the intermediate shaft 16. Note that the suctioned air flow Fa and the cooling air flow Fb do not interfere with each other in the cover 30. Also, the flow passage area around the cover 30 is uniformly reduced along the flowing direction of the fluid due to the cover 30.

The cooling air flow Fb that has been guided into the cover 30 flows out from a cover opening 30d near the suction port 12a where the negative pressure has been generated. The cooling air flow Fb that has flowed out meets the suctioned air flow Fa and is guided to the suction port 12a.

Note that the aforementioned motor 14 may be a motor 14 configured to cause the impeller 12 to rotate using electric power and assist a supercharging ability in a case in which the diesel engine is operated with low output power and discharged exhaust gas cannot give a sufficient supercharging ability to the turbocharger 10, or may be a generator that causes the rotor 14a to rotate via the drive shaft 18 coupled to the turbine, the coupling, and the intermediate shaft 16 and generates power in a case in which excessive exhaust gas is discharged from the diesel engine. In regard to the generator, the motor 14 may be caused to function as a generator.

According to the turbocharger 10 of the embodiment, the following advantages are achieved.

The cover 30 can curb an interference between mutual flows, namely the suctioned air flows Fa and the cooling air flow Fb outside and inside the cover 30. Also, it is possible to uniformly reduce the flow passage area around the cover 30 along the flowing direction of the fluid. In this manner, it is possible to prevent a decrease in speed of the suctioned air flow Fa by reducing a pressure loss of the suctioned air flow Fa guided to the suction port 12a of the impeller 12 or rectifying the suctioned air flow Fa. Also, it is possible to sufficiently secure the flow amount of the suctioned air flow Fa to be guided to the suction port 12a of the impeller 12. In other words, it is possible to efficiently guide the suctioned air flow Fa to the impeller 12.

At the same time, the cooling air flow Fb can reliably be guided into the motor 14 as well (the clearance between the rotor 14a and the stator 14c). This is because the cooling air flow Fb that has flowed out from the clearance between the rotor 14a and the stator 14c is not affected by an interference from the suctioned air flow Fa and the flow of the cooling air flow Fb can thus be maintained. Also, since the inner diameter of the cover 30 is greater than the outer diameter of the rotor 14a and is set to be similar to or greater than the inner diameter of the stator 14c, the cooling air flow Fb that has flowed out from the clearance between the rotor 14a and the stator 14c is unlikely to be affected by an interference from the cover 30. Further, the cooling air flow Fb that has flowed out from the clearance is guided into the cover 30, flows out from the cover opening 30d in the vicinity of the suction port 12a where the negative pressure has been generated, and then meets the suctioned air flow Fa. At this time, the outer diameter of the cover 30 is set to be equivalent to the hub diameter of the impeller 12. In a case in which the outer diameter of the cover 30 is greater than the hub diameter, an interference occurs between the cover 30 and the suctioned air flow Fa. Also, in a case in which the outer diameter of the cover 30 is smaller than the hub diameter, the cover opening 30d is excessively reduced in size, and it is not possible to efficiently guide the cooling air flow Fb to the vicinity of the suction port 12a. If the outer diameter of the cover 30 is equivalent to the hub diameter of the impeller 12, such phenomena can be avoided. It is possible to maintain the flow rate of the cooling air flow Fb in the cover 30 by causing the cover opening 30d to approach the suction port 12a where the negative pressure has been generated and efficiently guiding the cooling air flow Fb to the vicinity of the suction port 12a in this manner. As a result, it is possible to maintain the flow rate of the cooling air flow Fb distributed through the clearance between the rotor 14a and the stator 14c. These advantages improve cooling performance of the motor 14 using the cooling air flow Fb. In this manner, it is possible to raise output power without changing a physical size of the motor 14. Also, it is not necessary to additionally provide a cooling mechanism for cooling the motor 14, and cost reduction can thus be achieved.

In a case in which no cover 30 is provided in a coupling structure in which the motor 14 and the inlet of the impeller 12 are separated from each other, the suctioned air flow Fa and the cooling air flow Fb interfere with each other, the flows are disturbed, and this may lead to a probability that the suctioned air flow Fa cannot efficiently be guided to the impeller 12 and the performance of the turbocharger 10 is degraded or that the flow of the cooling air flow Fb cannot be maintained and the cooling performance of the motor 14 is degraded. Also, since the cooling air flow Fb meets the suctioned air flow Fa at a location separated from the vicinity of the suction port 12a where the negative pressure has been generated, a pressure difference from the vicinity of the suction port 12a is reduced, and this may lead to a probability that the cooling air flow Fb is not appropriately formed. Further, since the flow passage area around the cover 30 is steeply enlarged along the flowing direction of the fluid, there is a probability that the performance of the turbocharger 10 is degraded due to a pressure loss.

Also, it is possible to improve assembling properties of the cover 30 by configuring the cover 30 to be splittable along the longitudinal direction. The space in which the cover 30 is placed has to be accessed from a portion between the supports 14d on the upper side, and components such as the motor 14 and the intermediate shaft 16 are concentrated in the space. However, in a case in which the cover 30 is split into the upper cover 30a and the lower cover 30b, it is possible to reduce the size of the cover 30 that is caused to pass between the supports 14d into a half, which facilitates the access. Also, a state in which the lower cover 30b is assembled with the supports 14d on the lower side is achieved in advance, and components configuring the motor 14 and components such as the intermediate shaft 16 are then placed thereafter, for example. Then, the upper cover 30a is finally attached to the lower cover 30b secured in advance, and it is thus possible to improve assembling properties of the cover 30.

In addition, it is possible to secure the strength of the cover 30 using the ribs 30c even if the cover 30 is formed to have a thin structure by providing the ribs 30c along the longitudinal direction of the cover 30 and thereby to achieve weight reduction based on the thin structure of the cover 30.

### REFERENCE SIGNS LIST

10 Turbocharger
10a Compression unit
10b Suction part
10c Casing
10d Air inlet guide
12 Impeller
12a Suction port
12b Discharge port
12c Blade
12d Hub
14 Motor
14a Rotor
14b Body portion
14c Stator
14d Support
14e Bearing
16 Intermediate shaft
18 Drive shaft
20a First coupling (coupling)
20b Second coupling (coupling)
30 Cover
30a Upper cover
30b Lower cover
30c Rib
30d Cover opening
Fa Suctioned air flow
Fb Cooling air flow

1. A turbocharger comprising:
a suction part configured to suction a fluid;
an impeller configured to compress the fluid supplied from the suction part;
a drive shaft having one end to which the impeller is attached;
an intermediate shaft provided at the one end of the drive shaft such that the drive shaft extends in an axial direction from a downstream side to an upstream side of the impeller;
a motor or a generator having a rotor attached to a distal end of the intermediate shaft via a coupling, a stator provided so as to correspond to the rotor, and a body portion configured to hold the stator; and
a cover formed into a tubular shape to surround the intermediate shaft and the coupling.

2. The turbocharger according to claim 1, wherein
the suction part is provided on an upstream side of the motor or the generator, and
an inner diameter of the cover is greater than an outer diameter of the rotor.

3. The turbocharger according to claim 1, wherein an outer diameter of the cover is equivalent to an outer diameter of an end of a hub of the impeller on a side of the cover.

4. The turbocharger according to claim 1, wherein the cover is splittable along a longitudinal direction.

5. The turbocharger according to claim 1, wherein the cover is provided with a rib along a longitudinal direction.

6. The turbocharger according to claim 1, wherein the cover is attached on a side of the motor or on a side of the generator.
